(19) United States
(12) Patent Application Publication
(10) Pub. No.: US 2007/0147995 A1
(43) Pub. Date: Jun. 28, 2007

(54) Blower system

(75) Inventor: Yoshinori Araki, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/647,464

(22) Filed: Dec. 28, 2006

(30) Foreign Application Priority Data
Dec. 28, 2005 (JP) 2005-379552
Oct. 13, 2006 (JP) 2006-280358

(51) Int. Cl. F03B 3/16

(52) U.S. Cl. 415/204

(57) ABSTRACT

A blower system which is easy to maintain and obtains motor cooling air from the inside of the spiral casing, that is, a blower system wherein the blower case and the motor holding housing are comprised as separate members, the spiral casing is provided with an enlarged part enlarged in an axial direction to an opposite side from the suction port from the centrifugal type blower fan, the motor holding housing is provided with a holder storing and holding the motor, an extension extended from the holder in a diametrical direction of the fan, a circumferential wall formed connected with the extension and forming an inner circumferential wall of the enlarged part in the spiral casing, and a cooling air passage provided between the holder and the circumferential wall and guiding part of the air circulating inside the spiral casing as cooling air to the motor, and the cooling air passage has an inlet opening into which air flows from the spiral casing and having an outlet opening provided at the circumferential wall and out of which air flows to the motor.

### BACKGROUND OF THE INVENTION

1. Field of the Invention

The present invention relates to a blower system for a vehicular air-conditioning system etc.

2. Description of the Related Art

In general, a vehicular air-conditioning system is provided at the front of the front seats in the passenger compartment. It has an intake having a blower system for obtaining air from inside and outside of the compartment, a cooler for cooling the obtained air, and a heater for heating the cooling air.

The blower system provided at the intake is also disclosed in Japanese Patent Publication (A) No. 2002-347423. For example, as shown in FIG. 10, it has a blower case 1 in which a centrifugal type blower fan F is housed and a motor M driving the blower fan F. When this motor 14 drives the blower Fan F, the air inside the compartment or the air outside the compartment is selectively taken into the blower case 1 from an intake port 3 (also called a “bellmouth”) and flows from a discharge port (not shown) of the blower case 1 toward the later cooler or heater.

In this blower system, the blower case 1 and the motor M are connected by a cooling air passage 4. Part of the air flowing through a spiral casing 1a is guided into the motor M as cooling air and cools the motor M.

The blower case 1 is formed by upper and lower pieces P1 and P2 joined at a Parting line PL at an intermediate location in the motor axial direction. The lower piece P2 and the motor holding housing 2 holding the motor M are formed integrally. The cooling air passage 4 is comprised of a groove formed integrally in the lower piece P2 and covered by a cap from the fan F side. By configuring it in this way, the cooling air passage 4 from the inlet of the cooling air to the motor M can be formed by the shortest distance and the motor M can be efficiently cooled.

However, this blower system is an integral structure of the lower piece P2 of the blower vase 1 and the motor holding housing 2 joined together, so when the motor M has to be replaced, it becomes necessary to separate the upper piece P1 and lower piece P2 of the blower case 1 to remove the motor M. Usually, the blower case 1 is connected to the air-conditioning case having the cooler and heater, so when disassembling the blower case 1, it becomes necessary to disassemble the air-conditioning case and the maintenance efficiency becomes extremely poor.

If making the motor holding housing 2 and lower piece P2 separate, the above problem can be solved, but Japanese Patent Publication (A) no. 2002-347428 provides a cooling air passage 4 between the inner side of the blower case 1 and the motor M, so the lower piece P2 of the blower case 1 and the motor holding housing 2 must be made integral in structure.

### SUMMARY OF THE INVENTION

An object of the present invention is to provide a blower system which is easy to maintain and obtains motor cooling air from the inside of the spiral casing.

The present invention provides a blower system as means for achieving this object. According to the present invention, there is provided a blower system (100) provided with a centrifugal type blower fan (F) for blowing air, taken in through a suction port from the axial direction, to the outside in the diametrical direction, a motor (M) for driving rotation of the centrifugal type blower fan, a blower case (1) in which is formed a spiral casing (1a) guiding air sent by the centrifugal type blower fan outward in the diametrical direction to a discharge port, and a motor hold no housing (2) for holding the motor, the blower case (1) and the motor holding housing (2) being comprised as separate members, the spiral casing (1a) being provided with an enlarged part (1b) enlarged in an axial direction to an opposite side from the suction port from the centrifugal type blower fan, the motor holding housing being provided with a holder (2d, 2p) storing and holding the motor, an extension (2h) extended from the holder in a diametrical direction of the fan, a circumferential wall (2c) formed connected with the extension and forming an inner circumferential wall of the enlarged part in the spiral casing, and a cooling air passage (4) provided between the holder and the circumferential wall and guiding part of the air circulating inside the spiral casing as cooling air (x) to the motor, and the cooling air passage (4) having an inlet opening (2a) into which air flows from the spiral casing and having an outlet opening (2b) provided at the circumferential wall and out of which air flows to the motor.

In the blower system, the blower case and the motor holding housing are comprised as separate members, so when replacing the motor, there is no need to disassemble the blower case 1. The motor can be easily replaced by detaching the motor holding housing to which the motor is mounted from the blower case. Further, due to the above cooling air passage structure, the ease of motor replacement can be maintained and motor cooling air can be obtained from the inside of the spiral casing.

Preferably, the inlet opening (2a) is provided with inclined walls (2f) formed inclined with respect to the diametrical direction so as to enlarge the cross-sectional area of the passage toward the outside in the diametrical direction of the spiral casing (1a) and guiding the cooling air (x). Due to this, part of the air circulated through the inside of the spiral casing easily flows into the cooling air passage and as a result the flow rate of the cooling air can be made larger.

More preferably, the cooling air passage (4) is provided with a partition wall (2g) formed continuing with the extension (2h) and covering the blower fan side of the cooling air passage. Due to this, it is possible to prevent the sound of the stream of air striking the cooling air and to increase the cooling air low rate.

Still-more preferably, the partition wall (2g) extends from a location (2s) where two inclined walls (2f) approach each other the closest to an axial center side of the motor.

Still more preferably, the holder (2d, 2p) has side walls (2d) holding sides of the motor and a floor (2p) holding the motor bottom, the outlet opening (2p) is provided near the floor, and the cooling air passage (4) is provided with a first passage (2j) extending from the inlet opening toward the side walls of the holder and a second passage (2k) connected with the first passage, extending along the side walls of the holder, and leading to the outlet opening.

Still more preferably, an end (2s) of the partition wall (2g) at the spiral casing (1a) side and an axial center end (25) of the first passage floor (2n) forming the first passage (2j) are positioned on the same plane parallel to the axial direction of the motor. Due to this, when molding the motor holding housing from a resin, there is no need to use a slide mold and there is no need to use a separate member for forming the cooling air passage.

Still more preferably, the second passage (2k) is formed with an opening (2u) at an opposite side from the blower fan, the opening is provided with a lid (2l) and an end (2s) of the partition wall at the spiral casing side and an end (2y) of the opening at the spiral casing side are positioned on the same plane parallel to the axial direction of the motor. Due to this, when molding the motor holding housing from a resin, there is no need to use a slide mold and there is no need to use a separate member for forming the cooling air passage.

Still more preferably, the inlet opening (2a) is arranged between a spiral start (1x) and a spiral end (1y) of a spiral shape forming a functional part of the spiral casing (1a) and corresponding to a position shifted from the spiral start (1x) to the spiral end (1y) in a direction (−θ) opposite to the spiral direction (+θ). Due to this, it becomes possible to further increase the cooling air flow rate.

Still more preferably, a bottom (1b) of the spiral casing (1a) is formed on the same plane perpendicular to the motor axis From the spiral start to spiral end of the spiral casing.

Note that the reference numerals in the parentheses following the above means show the correspondence with the specific means described in the embodiments explained later.

### BRIEF DESCRIPTION OF THE DRAWINGS

These and other objects and features of the present invention will become clearer from the following description of the Preferred embodiments given with reference to the attached drawings, wherein:

FIG. 1 is a cross-sectional view of a blower system according to a first embodiment of the present invention,

FIG. 2 is a schematic too View of a blower system seen from the direction A in FIG. 1,

FIG. 3 is a perspective view of a motor holding housing of a blower system according to the first embodiment of the present invention,

FIG. 4 is a graph of the relationship between the cooling air inlet opening and cooling air flow rate of a blower system according to the first embodiment of the present invention,

FIG. 5 is a bottom view of the motor holding housing as seen from the direction B in FIG. 1,

FIG. 6 is a cross-sectional views of a motor holding housing according to the first embodiment of the present invention,

FIG. 7 is a cross-sectional view of a motor holding housing according to the first embodiment of the present invention right after shaping the resin,

FIG. 8 is a resin shaping mold of a motor holding housing according to the first embodiment of the present invention,

FIG. 9 is a resin shaping mold of a motor holding housing in the case where the length of the partition wall differs from the present invention, and

FIG. 10 is a cross-sectional view of a blower system of the related art.

### DESCRIPTION OF THE PREFERRED EMBODIMENTS

Below, embodiments of the present invention will be explained based on the drawings.

### First Embodiment

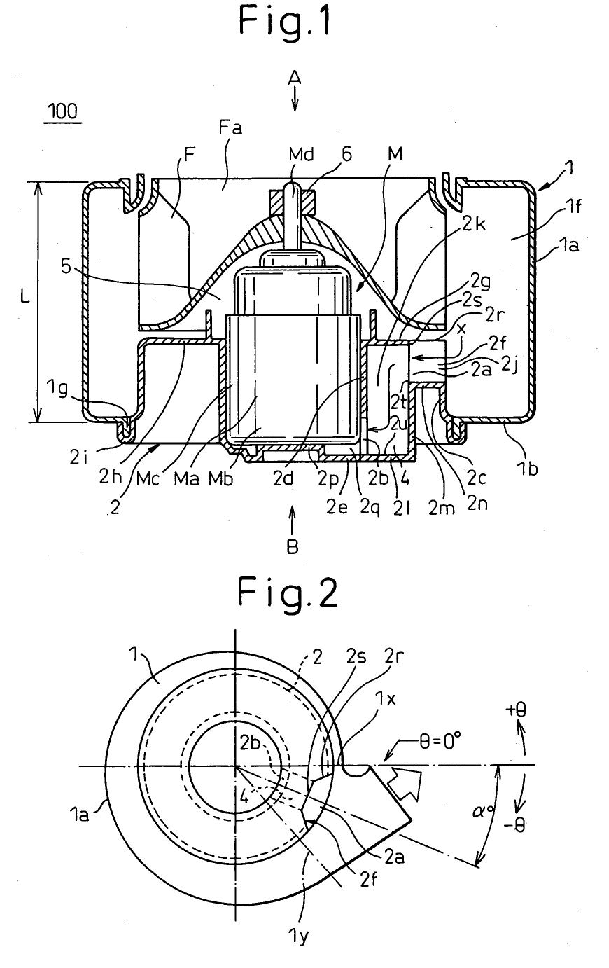

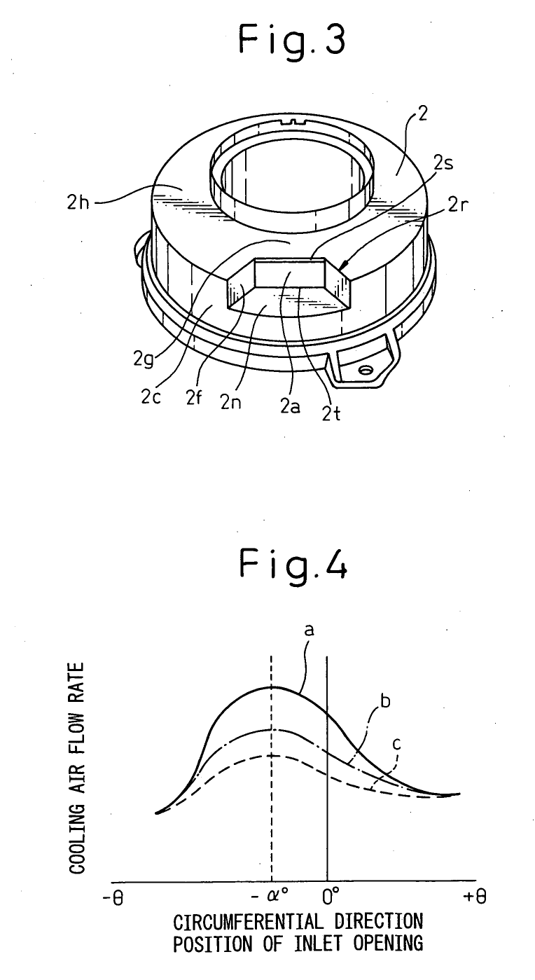

FIG. 1 is a cross-sectional view of a blower system according to a first embodiment of the present invention, FIG. 2 is a schematic top view of a blower system as seen from the direction A in FIG. 1, and FIG. 3 is a perspective view of a motor holding housing of a blower system according to the first embodiment of the present invention.

In FIG. 1, 100 indicates a blower system according to the present invent, F a centrifugal type blower fan, M a motor, 1 a blower case, 2 a rotor holding housing, 4 a cooling air passage, and 6 a fan fastening nut. 2a, 2b, 2c, 2d, 2e, 2f, and 2g show parts of the motor holding housing 2, where 2a shows an inlet opening, 2b an outlet opening, 2c a circumferential wall forming the spiral casing, 2d a side wall fastening and holding the motor side surface Mc, 2e a floor abutting against and holding the motor bottom Mb, 2f an inclined wall guiding the cooling air x, and 2g a partition wall. The blower case 1 and the motor holding housing 2 are separate members.

The blower system 100 is provided with a motor M, a centrifugal type multiblade blower fan F driven to rotate by the motor M and blowing air taken in through the suction port Fa outward in the diametrical direction, a blower case 1 having a spiral casing 1a surrounding this centrifugal type multiblade fan F and forming a spiral shaped air passage if through which air blown from the centrifugal type multiblade fare F is blown, and a motor holding housing 2.

The spiral casing 1a is provided with an enlarged part 1b expanding in an axial direction to an opposite side from the suction port Fa from the centrifugal type blower fan F and has an outer circumferential wall extended in parallel in the axial direction. The bottom 1b of the spiral casing 1a is formed on the same plane vertical to the motor shaft Md from the spiral start to spiral end of the spiral casino 1a. Further, the width L of the spiral casing 1a in the axial direction is substantially the same in the entire circumferential direction.

Further, the centrifugal type multiblade fan F is held at the substantial center of the spiral casing 1a. The motor M is fastened and held stored in the motor holding housing 2 placed at the substantial center of the spiral casing 1a. The shaft Md of the motor M is positioned at the approximate center of the spiral casing 1a. This shaft Md has the centrifugal type multiblade fan F connected to it by the fastening nuts 6.

As shown in FIG. 1 and FIG. 6, the motor holding housing 2 is provided with a holder (2d, 2p) provided at the opposite side to the suction port Fa and (directly holding the motor M. The holder (2d, 2p) is provided with a seat 2p for holding the bottom of the motor M and side walls 2d covering the outer circumference of the motor M. From the end of the side walls 2d at the blower fan F side, an extended wall 2h is integrally formed so as extend toward the spiral casing 1a. From the outer circumference of the end of the extended wall 2h at the spiral casing 1a side, a circumferential wall 2c functioning as an inner circumferential wall of the spiral casing 1a is integrally formed so as to extend in the direction opposite to the blower fan F. The circumferential wall 2c functions as the outer circumferential wall in the state of the motor holding housing alone.

Note that the length of this circumferential wall 2c in the direction opposite to the blower fan F is made the same along the entire circumferential direction. At the center of the floor 2e facing the bottom of the motor M, the seat 2p for holding the bottom of the motor M is formed. At the outer circumference of the seat 2p, a clearance 2q is formed between the bottom Mb of the motor M and the floor 2e. The motor holding housing 2 and the blower case 1 are connected boy engagement of a ring shaped projection 1g formed at the bottom of the blower case 1 and a ring shaped recess 2i formed at the end of the circumferential wall 2c of the motor holding housing 2.

Due to this, the motor holding housing 2 can be attached to and detached from the blower case 1 as an integral assembly of the floor 2e and side walls 2d for directly holding the motor M and the extended wall 2h and further the circumferential wall 2c forming part of the spiral casing 1a. Further, in the state with the motor holding housing 2 holding the motor M and with the blower fan F and motor M assembled, the blower fan F and motor M can be attached to and detached from the blower case 1 together with the motor holding housing 2. For this reason, the circumferential wall 2c forms part of the spiral casino 1a in the state with the motor holding housing 2 attached to the blower case 1, while functions as the outer circumferential wall of the motor holding housing 2 in the state with the motor holding housing 2 detached from the blower case 1. Further, when the motor M has to be replaced, there is no need to disassemble the blower case 1 like in Japanese Patent Publication (A) No. 2002-347428. It becomes possible to easily detach the motor 14 from the blower system 100.

Part of the blower case 1 forms the spiral casing 1a. The spiral casing 1a is formed so as to be expanded in the diametrical direction toward the discharge opening and forms a spiral shape as shown in FIG. 2. Inside this spiral casing 1a, air circulates after receiving centrifugal force from the blower fan F. Part of this air flow flows through the cooling air passage 4 in the illustrated arrow direction as cooling air x for cooling the motor M. The cooling air x first flows from the inlet opening 2a provided in the circumferential wall 2c to the inside of the cooling air passage 4, passes through the first passage 2j to strike the inside wall 2d, flows along the side wall 2d, is changed in direction to the floor 2e direction, and passes through the second passage 2k. The two ends of the inlet opening 2a in the fan rotation direction are provided with inclined walls 2f formed inclined with respect to the diametrical direction of the spiral casing so as to increase the passage cross-sectional area in the diametrical direction toward the outside and guide the cooling air x accordingly.

Meat, the cooling air x flows out from the outlet opening 2b provided near the floor 2e and at the side walls 2d and flows to near the motor bottom Mb. Further, the cooling air x passes from near the motor bottom Mb through the clearance (not shown) between the motor side surfaces Mc and the side walls 2d or through the inside of the motor housing Ma and rises toward the back space 5 of the blower fan F.

Due to the above, the cooling air x cools the motor bottom Mb, which first becomes highest in temperature, then cools the motor side surfaces Mc. Due to this, the motor M is evenly cooled.

Further, the first passage 2j forming the cooling air passage 4 is formed from the inclined walls 2f and circumferential wall 2c and a first passage floor 2n integrally formed with the same and extending toward the side walls 2d. The second passage 2k forming the cooling air passage 4 is comprised of a second passage floor 21 formed connected with the floor 2e, an outside wall 2m formed integrally with the first passage floor 2n and extending parallel to the side wall 2d in the axial direction of the motor M, and a partition wall 2g. The partition wall 2g extends from the location 2s where the two inclined walls 2f approach each other the closest to the axial center side of the motor M. The partition wall 2g forms part of the extended wall 2h and is formed connected with the extended wall 2h and covers the blower fan F side of the second passage 4. The end 2s of the partition wall 2g at the spiral casing 1a side and the outside wall 2m are positioned on the same plane parallel to the motor axial direction. That is, the end 2s of the partition wall 2g at the spiral casing 1a side and the end 2t of the first passage floor 2n forming part of the first passage 2j at the axial center side of the motor M are positioned on the same plane parallel to the motor axial direction.

Further, the outside wall 2m and the first passage floor 2n are integrally formed. Further, the partition wall 2g and side wall 2d are integrally formed. By this structure of the cooling air passage 4, the motor holding housing 2 can be made a compact design.

On the other hand, as shown in FIGS. 1 to 3, the inlet opening 2a is provided with the inclined walls 2f guiding the cooling air x. Due to this, the cooling air flow rate can be made larger. FIG. 4 is a graph of the relation of the inlet opening 2a end the cooling air flow rate. In FIG. 4, a is a graph of the case where the inlet opening 2a is provided with the inclined walls 2f and partition wall 2g, b is a graph of the case where the inlet opening 2a is provided with the inclined walls 2f and not provided with the partition wall 2g, and c is a graph of the case where the inlet opening 2a is not provided with the inclined walls 2f or the partition wall 2g. These are based on actual measurements. The ordinate in FIG. 4 indicates the cooling air flow rate, while the abscissa indicates the circumferential direction position of the inlet opening 2a (explained later). As will be understood from FIG. 4, in both the case a and b where the inclined walls 2f are provided, the flow rate is larger than the case c where they are not provided. Further, the case a where the partition wall 2g is provided is larger in flow rate than the case b where it is not provided. Further, it is understood that the inlet opening 2a provided with both the inclined walls and partition wall becomes greatest in cooling air flow rate.

Here, the circumferential direction position of the inlet opening 2a will be explained. The inlet opening 2a is provided in the motor holding housing 2. Further, as shown in FIG. 2, it is arranged corresponding to a position shifted slightly from a spiral start 1x and a spiral end 1y of the spiral shape forming the functional part of the spiral casing in a direction (−θ) opposite to the spiral direction (+θ). Due to this, the cool no air flow rate can be made further larger.

FIG. 4 shows the relationship between the circumferential direction position of the inlet opening 2a and the cooling air flow rate. When the circumferential direction position of the inlet opening 2a is α°, it is learned that the cooling air flow rate becomes larger.

Note that the partition wall 2g has the role of preventing the air engaged in free spiral motion in the spiral casing from striking the cooling air. If eliminating this, the air stream will strike the cooling air and cause noise or the cooling air flow rate will fall. Further, no partition wall is formed at the location 2r of the inclined wall 2f at the fan F side. This is because it is advantageous of intake of air. Further, a plurality of inlet openings 2a may also be provided.

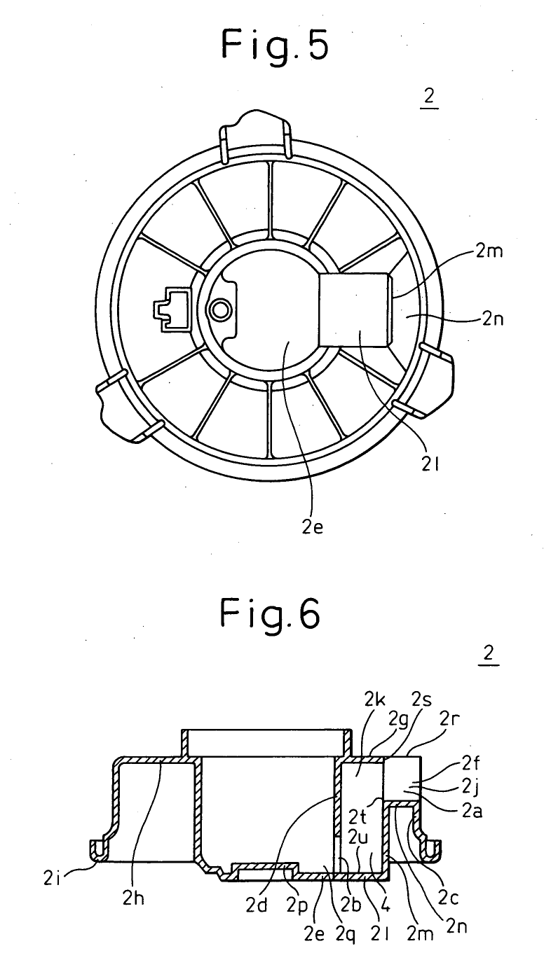

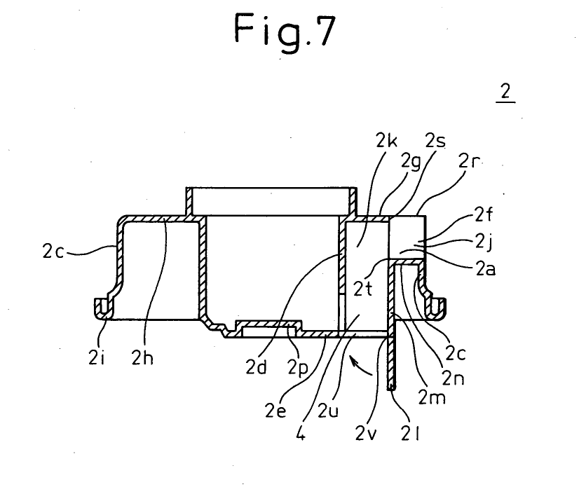

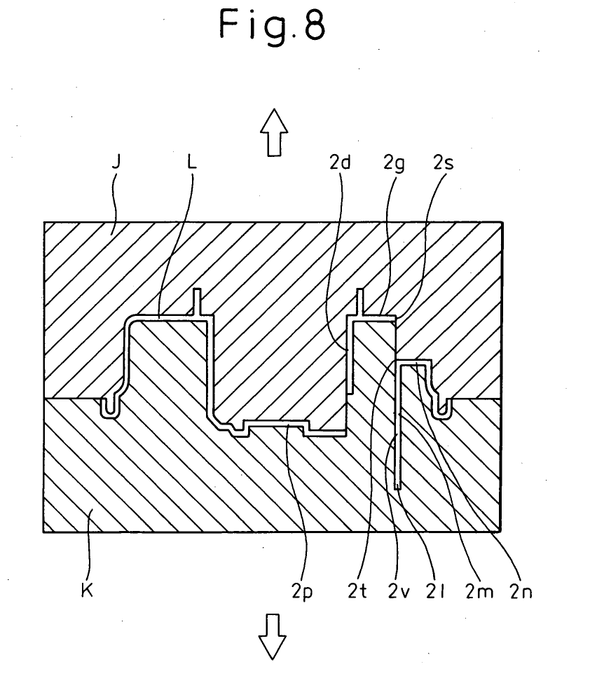

Next, the method of molding the resin of the motor holding housing 2 will be explained with reference to FIGS. 5 to 8. FIG. 5 is a bottom view of the motor holding housing as seen from the direction B in FIG. 1, FIG. 6 is a cross-sectional view of a motor holding housing according to the first embodiment of the present invention, FIG. 7 is a cross-sectional view of a motor holding housing according to the first embodiment of the present invention right after shaping the resin, and FIG. 8 is a resin shaping mold of a motor holding housing according to the first embodiment of the present invention.

The motor holding housing 2 is fabricated by the injection molding method using a thermoplastic resin such as polypropylene. This injection molding method uses the molds J and K as shown in FIG. 8 to fabricate the motor holding housing 2. J indicates an upper mold, K a lower mold, and L a cavity into which the resin melted by heat flows and solidifies.

When the molds J and K are combined, a cavity L sealed except at the gate opening and runner (both not shown) is formed. Next, the resin heated and melted in the cylinder of the injection molding machine (not shown) passes through the gate opening and runner and flows into and fills the cavity L. The resin filled in the cavity L is robbed of heat by the molds J and K and solidifies. After the resin solidifies, the molds J and K, as shown by the arrows in FIG. 8, are opened by moving the under mold J in the upper direction and moving the lower mold F in the lower direction. This mold opening operation enables the shaped article to which the shape of the cavity L is transferred, that is, the motor holding housing 2, to be taken out from the molds J and K.

The motor holding housing 2 right after being taken out from the molds J and K, as shown in FIG. 7, has the lid 21 for forming the second passage floor (see FIG. 5) and the outside wall 2m connected in a straight line. Next, the lid 21 of the motor holding housing 2 is bent in the arrow direction at the point 2v and connected to the floor 2e to close the opening 2u. The lid 21 can also be made a separate member.

The motor holding housing 2 of the present invention mainly has the following two shape features, so the shaping mold need only be made of the tapper mold J and lower mold K. That is, the first point is that the end 2s of the partition wall 2g at the spiral casing 1a side and the end 2t of the first passage floor 2n forming part of the first passage 2j at the axial center side of the motor M are positioned on the same plane parallel to the motor axial direction. The second point is that the second passage 2k is formed with an opening 2k at the opposite side from the blower fan F, the opening 2k is provided with a lid 21, and the end 2s of the partition wall 2g on the spiral casing 1a side and the end 2v of the opening 2k on the spiral casing 1a side are positioned on the same plane parallel to the motor axial direction.

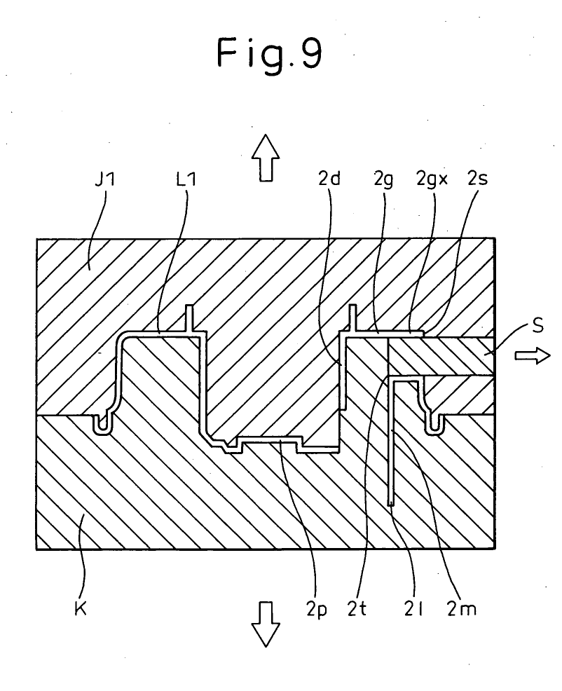

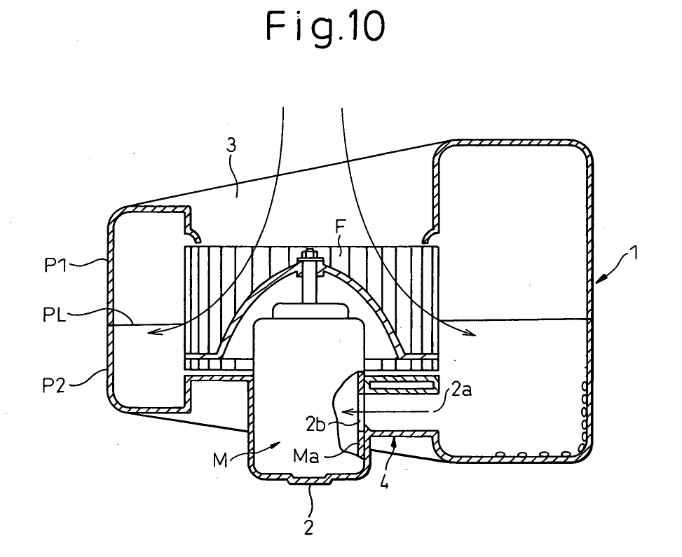

The case where the first shape feature is not provided in the motor holdings housing 2 will be explained with reference to FIG. 9. FIG. 9 shows a shaping mold for a motor holding housing 2x where the end 2s of the partition wall 2g at the spiral casing 1a side extends further to the spiral casing 1a side than the end 2t of the first passage floor 2n forming part of the first passage 2j at the axial center side of the motor M.

The partition wall 2g has a part 2gx extending further to the spiral casing la side than the end 2t of the first passage floor 2n at the axial center side of the motor M. For this reason, the two molds can no longer be opened in the vertical direction, the slide mold S is necessary, and the mold structure becomes complicated. In this case, the molten resin is filled in the cavity L1 and solidified, then first the slide mold S is moved in the horizontal direction of the figure along the arrow to separate it from the upper mold J1, then the upper meld J1 and lower mold K are moved in the upper and lower directions so as to open the mold and take out the shaped article, that is, the motor holding housing 2x.

In the above way, the present embodiment can provided a blower system which is easy to maintain ant can obtain motor cooling air from the inside of the spiral casing.

### Other Embodiment

The inlet opening 2a may also use the first passage floor 2n as an inclined wall and be formed to be inclined with respect to the diametrical direction of the spiral casing so as to enlarge the passage cross-sectional area in the diametrical direction toward the outside.

While the invention has been described with reference to specific embodiments chosen for purpose of illustration, it should be apparent that numerous modifications could be made thereto by those skilled in the art without departing from the basic concept and scope of the invention.

1. A blower system provided with:
a centrifugal type blower fan for blowing air, taken in through a suction port from the axial direction, to the outside in the diametrical direction,
a motor for driving rotation of said centrifugal type blower fan,
a blower case in which is formed a spiral casing guiding air sent by said centrifugal type blower fan outward in the diametrical direction to a discharge port, and
a motor holding housing for holding said motor,
said blower case and said motor holding housing being comprised as separate members,
said spiral casing being provided with an enlarged part enlarged in an axial direction to an opposite side from said suction port from said centrifugal type blower fan,
said motor holding housing being provided With a holder storing and holding said motor, an extension extended from said holder in a diametrical direction of said fan, a circumferential wall formed connected with said extension and forming an inner circumferential wall of said enlarged part in said spiral casing, and a cooling air passage provider between said holder and said circumferential wall and guiding part of the air circulating inside said spiral casing as cooling air to said motor, and
said cooling air passage having an inlet opening into which air flows from said spiral casing and having an outlet opening provided at said circumferential wall and out of which air flows to said motor.

2. A blower system as set forth in claim 1, wherein said inlet opening is provided with inclined walls formed inclined with respect to said diametrical direction so as to enlarge the cross-sectional area of the passage toward the outside in the diametrical direction of the spiral casing and guiding said cooling air.

3. A blower system as set forth in claim 1, wherein said cooling air passage is provided with a partition wall formed continuing with said extension and covering said blower fan side of said cooling air passage.

4. A blower system as set forth in claim 3, wherein said Partition wall extends from a location where two said inclined walls approach each other the closest to an axial center side of said motor.

5. A blower system as set forth in claim 1, wherein said holder has side walls holding sizes of said motor and a floor holding said motor bottom, said cutlet opening is provided near said floor, and said cooling air passage is provided with a first passage extending from said inlet opening toward said side walls of said holder and a second passage connected with said first passage, extending alone said side walls of said holder, and leading to said outlet opening.

6. A blower system as set forth in claim a, wherein an end of said partition well at said spiral casing side and an axial center end of the first passage floor forming said first passage are positioned on the same plane parallel to the axial direction of said motor.

7. A blower system as set forth in claim 5, wherein said second passage is formed with an opening at an opposite side from said blower fan, said opening is provided with a lid, and an end of said partition wall at the spiral casing side and an end of said opening at the spiral casing side are positioned on the same plane parallel to the axial direction of said motor.

8. A blower system as set forth in claim 1, wherein said inlet opening is arranged between a spiral start and a spiral end of a spiral shape forming a functional part of said spiral casing and corresponding to a position shifted from said spiral start to said spiral end in a direction opposite to the spiral direction.

9. A blower system as set forth in claim 1, wherein a bottom of said spiral casing is formed on the same plane perpendicular to the motor axis from the spiral start to spiral end of said spiral casing.
